(19) United States
(12) Patent Application Publication
(10) Pub. No.: US 2018/0000284 A1
(43) Pub. Date: Jan. 4, 2018

(54) CONTINUOUS CONVEYOR BELT FOR FOOD HEATING DEVICE

(71) Applicant: PRINCE CASTLE LLC, Carol Stream, IL (US)

(72) Inventors: Matthew Adomaitis, Aurora, IL (US); Frank Anthony Agnello, Huntley, IL (US); Richard Bauer, Palatine, IL (US); Eloy Cerda, Westchester, IL (US); Mark Edward Fastabend, Chicago, IL (US); Sean Patrick Forrest, Park Ridge, IL (US); Charles B. Hartfelder, Hanover Park, IL (US); Karl R. Heinze, Chicago, IL (US); Scott R. Hammac, Joliet, IL (US); Kyle Thomas Kestner, Schaumburg, IL (US); Christine Suen Laub, Roselle, IL (US); Eugene Stanley Maslana, Morton Grove, IL (US); Calvin States Nelson, Round Lake Beach, IL (US); Laurence A. Schoell, Shorewood, IL (US); Zoran Ulicevic, Wheaton, IL (US); Aleksandr Yazvin, Glenview, IL (US); Loren Veltrop, Chicago, IL (US); Brian J. Truesdale, Carol Stream, IL (US); Dennis Malkowski, Yorkville, IL (US)

(73) Assignee: PRINCE CASTLE LLC, Carol Stream, IL (US)

(21) Appl. No.: 15/635,498

(22) Filed: Jun. 28, 2017

Related U.S. Application Data
(60) Provisional application No. 62/356,515, filed on Jun. 29, 2016.

(51) Int. Cl. A47J 37/04; B65G 15/48; B65G 15/44; B65G 15/54; H05B 6/12; H05B 6/10

(52) U.S. Cl. CPC A47J 37/045; H05B 6/12; H05B 6/107; B65G 15/44; B65G 15/54; B65G 15/48; B65G 2201/0202

(57) ABSTRACT

A food heating device includes a conveyor belt having a loop provided by a unitary, continuous sheet of metal or other suitable material.

### FIELD OF THE INVENTION

The present disclosure is directed to a conveyor belt loop for use in a food heating device. More particularly, the disclosure is directed to a continuous conveyor belt that provides a surface that can reduce product marking, minimizes costs, and simplifies manufacturing and assembly.

### BACKGROUND OF THE INVENTION

In the food preparation industry often food items are prepared, at least partially, by placing the food items on a conveyor belt that transports the food items into a food preparation device, such as a toaster. Such toasters include a heated platen and a slowly rotating conveyor belt. The conveyor belt holds the food item in close proximity to the platen while the conveyor belt simultaneously transports the food item through the preparation device. The length of time the food item is exposed to the heated platen may vary based on the length of the platen and the speed of the conveyor belt. Such toasters may process food items continuously as opposed to household toasters that process food items in batch mode, such as two or four pieces of bread at a time. Conveyor toasters are ill-suited for consumer use because of their size, manufacturing cost, power requirements, and the time required to pre-heat the platen to operating temperature. However, conveyor toasters are preferred by restaurants and food services that require high-volume through-put and consistent heating/toasting.

Conveyor toasters generally include a wire conveyor belt. Wire conveyor belts are ideal for material handling, cooking, icing, slicing breading, cooling, filling, inspecting, and packing of products like breads, rolls, buns, donuts, confections, cakes, pies, pastries, meat, seafood, poultry, and other processed foods. The simple, open design of wire conveyor belts provides efficient operation with minimum maintenance and easy cleanup to meet sanitation requirements. The wire conveyor belt may include a plurality of spaced metal rods interconnected by coupling “hook” and “loop” connection elements formed at the rod ends of adjacent metal rods. The rods may support a food item and the rods may hold the components of the belt together by way of the interconnected hook and loop connection elements.

One known conveyor belt, for example, is the wire conveyor belt disclosed in U.S. Pat. No. 7,987,972, which is herein incorporated by reference in its entirety. The wire conveyor belt provides a flat support surface, but is relatively expensive to produce and is cumbersome to assemble and relatively difficult to repair or replace in the field. The plates are attached to a first spaced rod at a first end and to a second spaced rod that is adjacent to the first spaced rod at the second end.

### SUMMARY

In accordance with one exemplary aspect of the present invention a food heating device includes at least one conveyor belt for carrying food products, at least one platen for heating the food products, and at least one driving mechanism for rotating the at least one conveyor belt in a direction of conveyance travel. The at least one conveyor belt includes a loop provided by a unitary, continuous sheet of metal, the loop having a top side and a bottom side, the top side being substantially parallel to and facing the at least one platen. The at least one conveyor belt moves relative to the at least one platen and transports a food product to allow the food product to be exposed to the at least one platen.

In accordance with another exemplary aspect of the present invention, a food heating device includes at least one conveyor belt for carrying food products, at least one platen for heating the food products, and at least one driving mechanism for rotating the at least one conveyor belt in a direction of conveyance travel. The at least one conveyor belt includes a loop provided by a mesh formed from a plurality of interlocked and inseparable rings, the loop having a top side and a bottom side, the top side being substantially parallel to and facing the at least one platen. The at least one conveyor belt moves relative to the at least one platen and transports a food product to allow the food product to be exposed to the at least one platen.

In accordance with yet another exemplary aspect of the present invention, a food heating device includes a conveyor belt for carrying food products, the conveyor belt forming a loop, the conveyor belt including a loop provided by a unitary, continuous sheet of metal, the loop having a top side and a bottom side, the conveyor belt comprising a receiving surface and an inner surface. A heat source for heating food products is disposed within the conveyor belt loop and configured to heat the conveyor belt. The conveyor belt moves relative to the at least one heat source and transports a food product to allow the food product to be exposed to the least one heat source.

### BRIEF DESCRIPTION OF THE DRAWINGS

FIG. 1 is a perspective view of a conveyor belt constructed in accordance with the teachings of the disclosure.

FIG. 2 is a side view of the conveyor belt of FIG. 1.

FIG. 3 is a perspective view of another embodiment of a conveyor belt constructed in accordance with the teachings of the disclosure.

FIG. 4 is a side view of the conveyor belt of FIG. 3.

FIG. 5 is a perspective view of yet another embodiment of a conveyor belt constructed in accordance with the teachings of the disclosure.

FIG. 6 is a side view of a barrier wall.

FIG. 7 is a perspective view of a plurality of barrier walls of FIG. 6 disposed on a conveyor belt.

FIG. 8 is a side view of the conveyor belt of FIG. 7.

FIG. 9 is a perspective view of a conveyor belt having an alternate embodiment of a barrier wall.

FIG. 10A is a perspective view of yet another alternate embodiment of a barrier wall.

FIG. 10B is a side view of the barrier wall of FIG. 10A.

FIG. 11 is a side view of a conveyor belt having the barrier wall of FIGS. 10A and 10B.

FIG. 12 is a side view of a conveyor belt assembly including a heated platen.

FIG. 13 is a side view of an alternate embodiment of a conveyor belt assembly including an inductive coil.

FIG. 14 is a perspective view of a vertical food heating device including a conveyor belt constructed in accordance with the teachings of the disclosure.

FIG. 15 is a side view of a horizontal food heating device including a conveyor belt constructed in accordance with the teachings of the disclosure

### DETAILED DESCRIPTION

A food heating device, as disclosed herein, heats and conveys a food product without substantially marking or pinching the food product. A conveyor belt assembly for use within a heating device provides a continuous support surface for conveying an item, particularly a food item, the continuous support surface being structured and arranged to receive, grip, and retain the item. One embodiment of the food heating device includes at least one heated platen for heating a product. In another embodiment, the food heating device includes at least one inductive coil for heating a food product. The conveyor belt of either embodiment may be a loop provided by a unitary, continuous sheet of metal, interwoven fabric, or mesh.

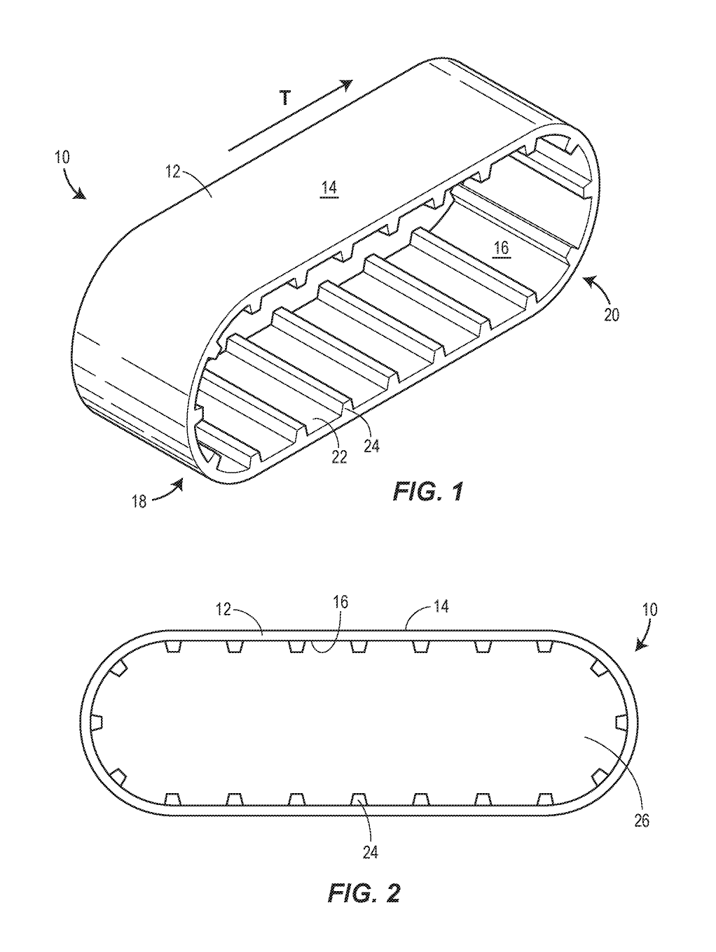

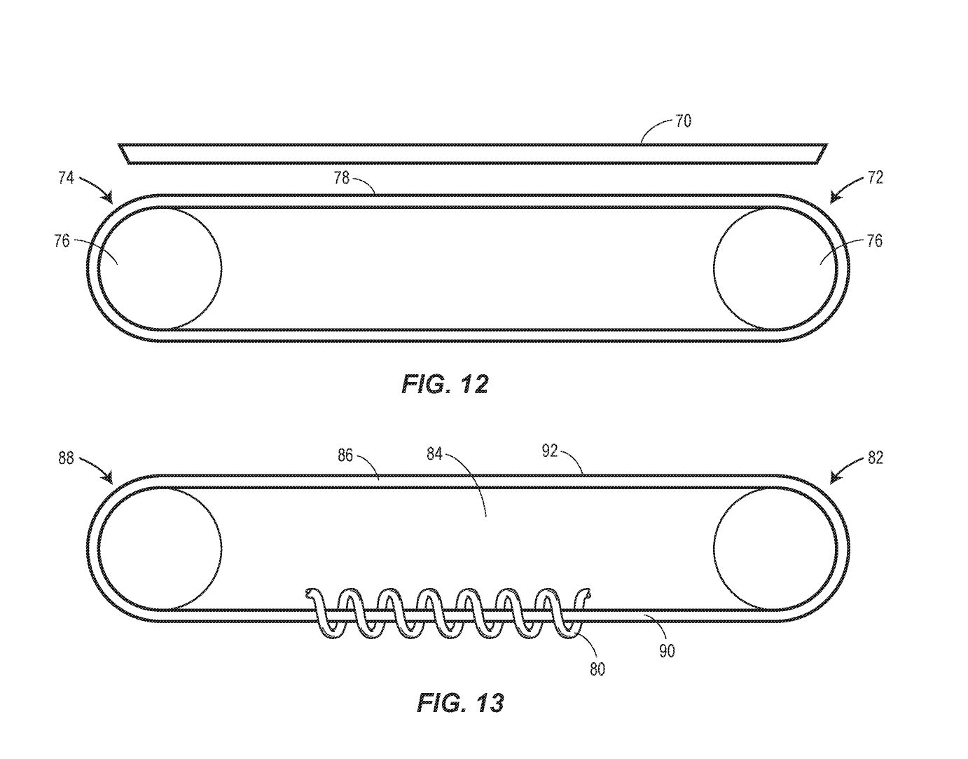

A conveyor belt 10 according to FIG. 1 includes a loop 12 formed by a unitary, continuous sheet of material, the loop 12 having a top side 14 and a bottom side 16, the top side 14 being adapted to receive, grip, and retain a food product. The conveyor belt 10 moves relative to at least one platen or inductive coil (as illustrated in FIGS. 12 and 13) and transports a food product to allow the food product to be exposed to the at least one platen or inductive coil. The food heating device includes at least one driving mechanism located at a first end 18 or a second end 20 of the loop 12 of the conveyor belt 10 for rotating the conveyor belt 10 in a direction of conveyance travel T.

In the first embodiment illustrated in FIGS. 1-2, the unitary loop 12 includes the top side 14 adapted to receive a food product and carry the food product from a first end 18 of the loop 12 to an opposite or second end 20 of the loop 12. A bottom side 16 of the conveyor belt 10 provides a corrugated surface 22 having a plurality of ridges 24 that are adapted to mate with a plurality of furrows of a driving mechanism, such as a sprocket. The driving mechanism may be located at first and second ends 18, 20 and disposed within a space 26 formed by the loop 12. A coating, such as a rubber coating, may be disposed on the bottom side 16 of the conveyor belt 10, the rubber coating forming the corrugated surface 22. The loop 12 may be formed from a flat sheet of material having first and second ends that are welded, or otherwise sealed, together to form an oblong loop 12. Alternatively, the loop 12 may be manufactured as a complete loop without requiring welding or sealing.

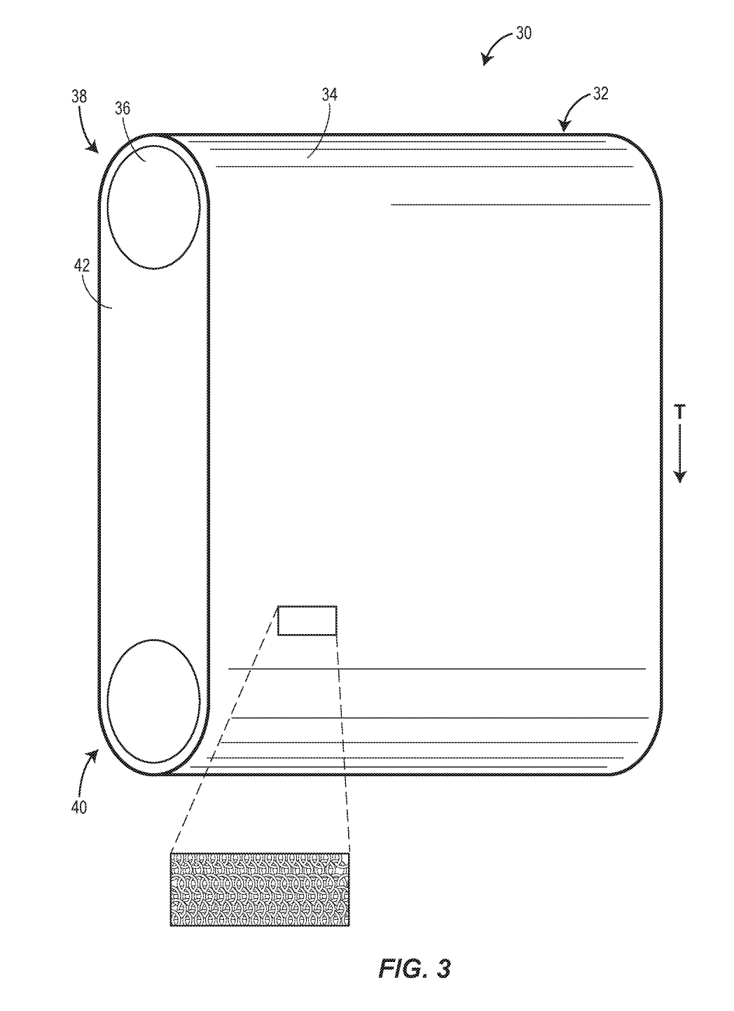

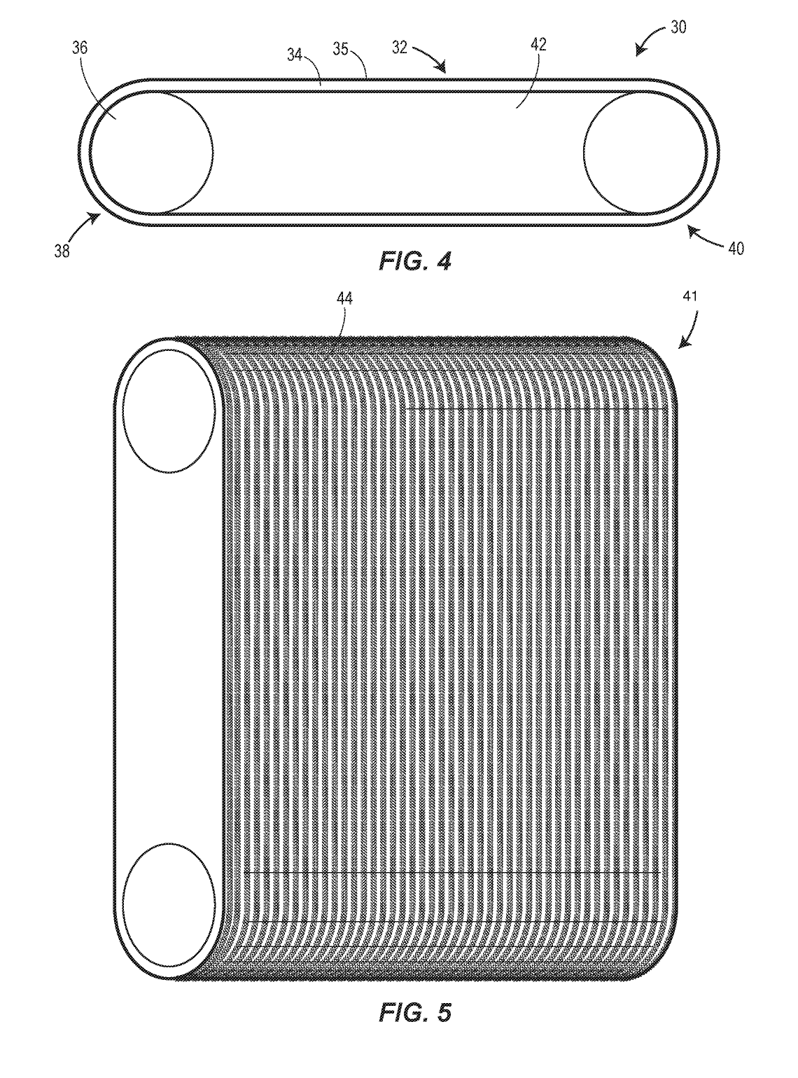

The embodiment illustrated in FIGS. 3-4 includes a conveyor belt assembly 30 comprising a conveyor belt 32 forming a loop 34 and first and second rollers 36 that drive the conveyor belt 32 in a direction of conveyance travel T. The loop 34 in FIG. 3 is made of a mesh, which may be formed from a single perforated sheet of material or from a plurality of interlocked and inseparable rings forming a continuous sheet, such as chain-mail. The first and second rollers 36 are located at first and second ends 38, 40 of the loop 34 and disposed within a void 42 formed by the loop 34. A top side 35 of the loop 34 is adapted to receive, grip, and retain a food product to be conveyed.

FIG. 5 illustrates a conveyor belt assembly 41 including a conveyor belt 44 that is made of a tightly-woven material or other material made of fabric.

The conveyor belts described herein may be manufactured from any suitable material, but are preferably formed from an extrudable material including, but not limited to, extrudable metals, which include, but are not limited to, aluminum, brass, copper, magnesium, and steel. The conveyor belt loops may be made of extrudable plastics and interwoven fabrics. Exemplary extrudable plastics include, but are not limited to, polyvinylchlorides, polyethylenes, polypropylenes, acetals, acrylics, nylons (polyamides), polystyrene, acrylonitrile butadiene styrenes, and polycarbonates. Other conveyor belts may be made of a high temperature resistant material such as highly saturated nitrile. The conveyor belt loops may be formed as a pre-formed loop, or may be formed from a single sheet of material having two ends welded, or otherwise sealed together.

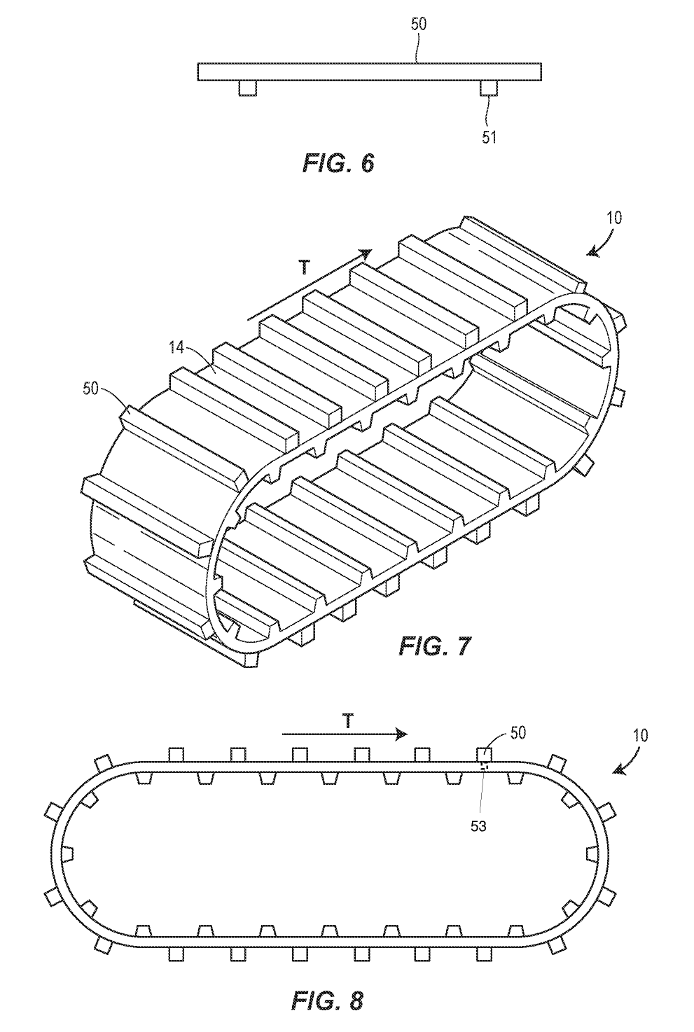

Any of the embodiments of the conveyor belts described herein may include a barrier wall 50, for example as illustrated in FIG. 6, to separate or divide the items to be conveyed, such as food products, on the conveyor belt 10. The barrier wall 50 includes legs 51 that can fit into apertures 53 (FIG. 8) disposed within the conveyor belt 10. The first example illustrated in FIGS. 7-8 includes the conveyor belt 10 of FIGS. 1-2 having a plurality of barrier walls 50. In this illustrated embodiment, the barrier walls 50 may be placed at predetermined locations on the top side 14 of the conveyor belt 10 to divide a portion of the belt 10 into a plurality of separated compartments. In this illustrated example, the barrier walls 50 are spaced apart and disposed across the top side 14 of the conveyor belt 10 such that the barrier walls 50 are oriented in a direction substantially perpendicular to the direction of conveyance travel T.

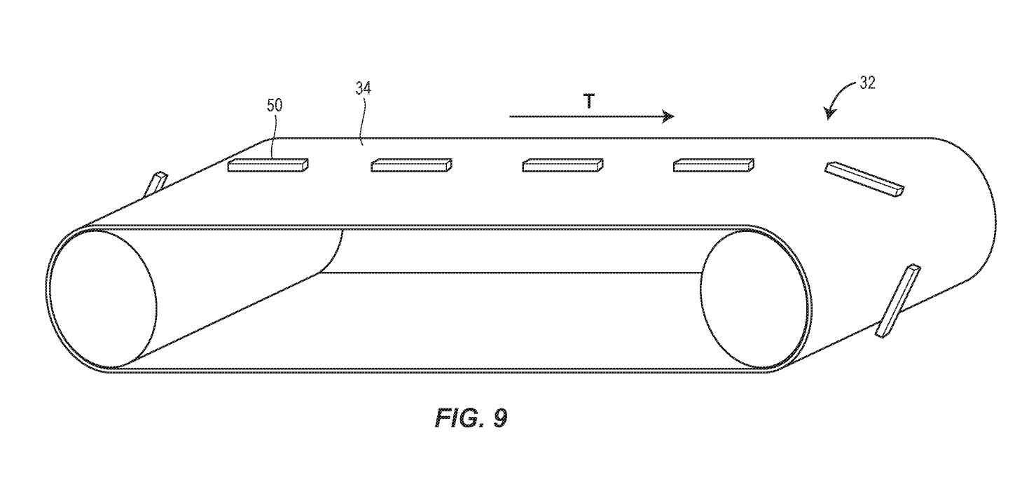

In another embodiment illustrated in FIG. 9, the conveyor belt 32 of FIGS. 3-4 includes a plurality of barrier walls 50 oriented in a direction substantially parallel to the direction of conveyance travel T.

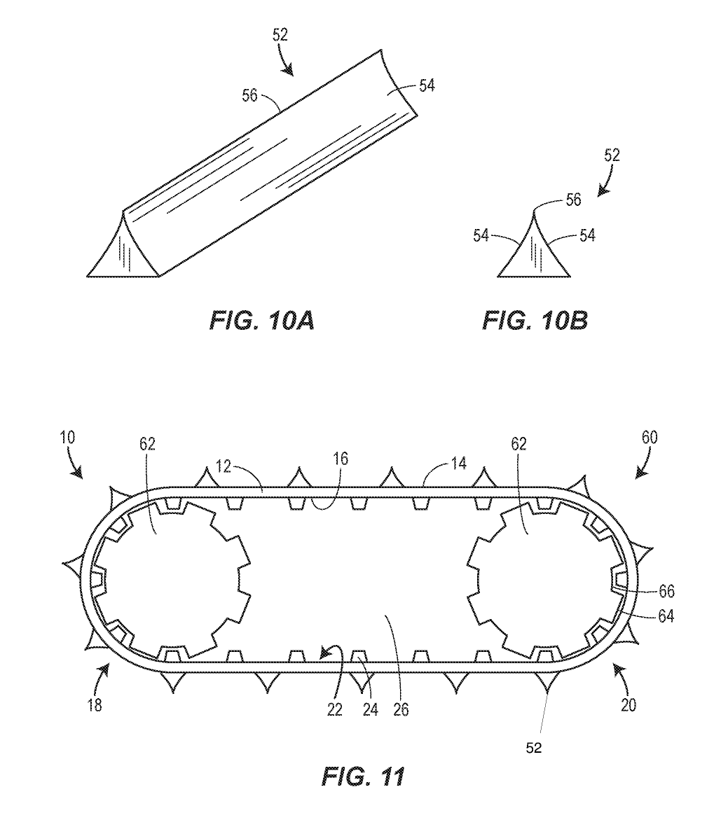

Another embodiment of a barrier wall 52 is illustrated in FIGS. 10A-10B. The barrier wall 52 includes first and second angled sides 54 that meet at a peak 56 of the barrier wall 52. In some embodiments, the first and second angled sides may be curved (concave or convex), as illustrated in FIG. 10B.

The barrier walls 50, 52 may serve to index food product to be conveyed by the conveyor belt 10, 32. For example, the barrier walls 50, 52 may prevent overloading the conveyor belt 10, 32, or they may be used to index the amount of food product conveyed. The barrier walls 50, 52 may also prevent the food product from moving or getting moved by other food products on the same conveyor belt assembly.

Referring now to FIG. 11, a conveyor belt assembly 60 includes the conveyor belt 10 of FIGS. 1-2 and also includes a first sprocket 52 and a second sprocket 62 located at the first end 18 and the second ends 20 of the loop 12, respectively, and the first sprocket 52 and the second sprocket 52 are disposed within the space 26 created by the loop 12. The conveyor belt assembly 60 also includes a plurality of barrier walls 52, for example the barrier walls 52 described above and illustrated in FIGS. 10A-10B. Each sprocket 62 has a plurality of teeth 64 and a plurality of furrows 66 between the teeth 64. To drive the conveyor belt 10, the teeth 64 of the sprockets 62 engage the corrugated surface 22 of the bottom side 16 of the loop 12. More specifically, the furrows 66 of the sprockets 62 engage the ridges 24 of the corrugated surface 22 of the loop 12. The sprockets 62 drive the conveyor belt 10 into rotational and translational motion.

In the embodiment illustrated in FIG. 4, the conveyor belt 34 is driven by first and second rollers 36 rather than by sprockets.

A food heating device may include a heat source and any of the conveyor belt embodiments described above and illustrated in FIGS. 1-11. To heat the food product, a conveyor belt moves relative to at least one heat source, a heated platen, an inductive coil, or both, and exposes the food product to the least one heat source.

A first embodiment, illustrated in FIG. 12, includes a heated platen 70 located parallel to and facing a conveyor belt assembly 72, which includes a conveyor belt 74 and first and second rollers 76. A top side 78 of a conveyor belt 74 faces the heated platen 70. In some embodiments, the heated platen 70 may contact the food product as the food product is being conveyed by the conveyor belt assembly 72. In other embodiments, the food product may remain spaced from the heated platen 70.

FIG. 13 illustrates another embodiment of the conveyor belt assembly 82 including an inductive coil 80 disposed at least partially within a space 84 formed by a loop 86 of a conveyor belt 88. The inductive coil 80 provides heat through induction, for example, by winding an electromagnet, such as iron wire, around the conveyor belt loop 86 at a return side 90 of the conveyor belt loop 86 and passing a high-frequency alternating current (AC) through the electromagnet. Alternatively, the coil 80 may be entirely disposed within the space 84 of the loop 86 or wrapped around a top side 92 of the conveyor belt 88 such that the inductive coil 80 would not interfere with the food products being conveyed. Through induction heating, the conveyor belt 88 may be heated such that the food product is heated when the product is in contact with the conveyor belt 88.

The embodiments disclosed herein may be employed in a number of conventional food heating devices. In one embodiment, a heating device including the conveyor belt assembly according to the disclosure advantageously transports one or more food products in a direction, e.g. horizontally or vertically downward along a heated platen or inductive coil so as to expose the food products to the energy radiating from the platen or inductive coil. Any of the embodiments disclosed herein may be part of the conveyor belt assembly that can be used in many food heating devices, such as toasters, that require one or more conveyor belt assemblies.

For example, the conveyor belt assembly can be implemented in a vertically oriented food heating device. A conventional vertical food heating device 100 illustrated in FIG. 14 employs two conveyor belt assemblies as is generally known in the art and as disclosed in, for example, U.S. Pub. No. 2010/0275789, which is incorporated herein by reference in its entirety.

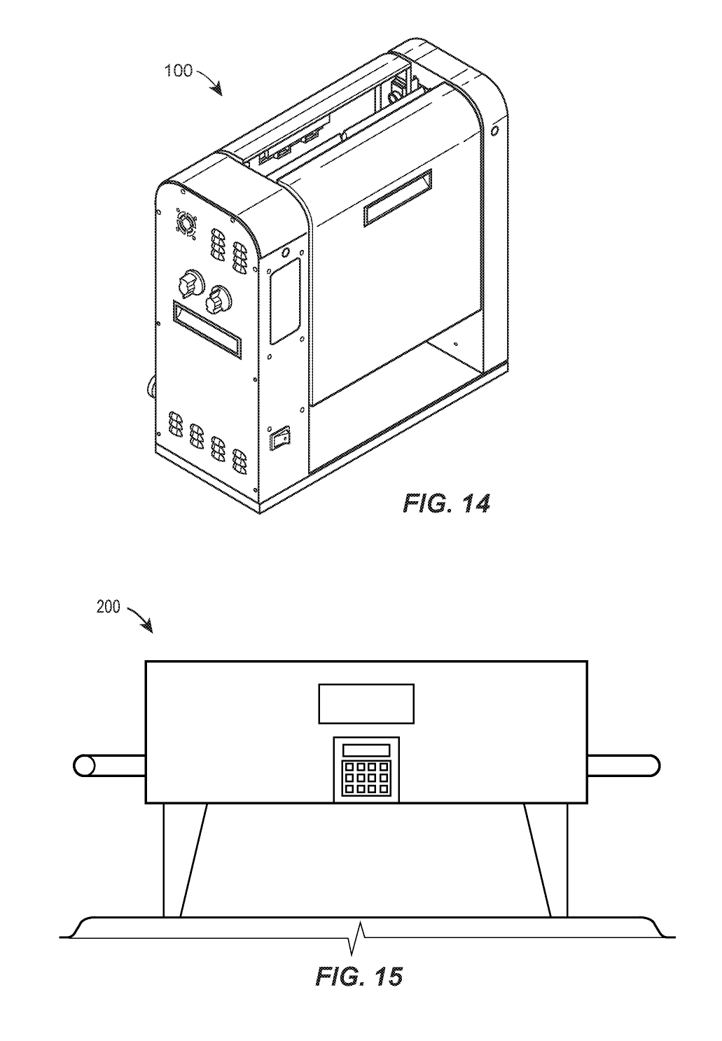

A conventional horizontal food heating device 200 illustrated in FIG. 15 is disclosed in U.S. Pat. No. 7,800,023, which is incorporated by reference in its entirety. The conveyor belt assembly may be included in the horizontal food heating device 200.

In each embodiment, the conveyor belt is configured to carry items, such as food products, over a distance of the conveyor belt loop. The top side of the conveyor belt can be corrugated or textured to grip an item during translational motion. The top side of the conveyor belt therefore can include gripping features to retain the item while the item is transported. The gripping features create friction between the conveyor belt and the item to be conveyed so that the conveyor belt retains contact with the item during conveyance. The gripping features are typically integrally formed on the top side of the conveyor belt and may take the shape of a series of parallel rows of sharp ridges and furrows. Of course, similar features can be added post-manufacturing and/or take other geometrical shapes to enhance friction between the top side and the item to be conveyed. The gripping features allow the top side to grip on to any kind of surface the item may have, for example, a round or very smooth item that can easily move or slide while being transported. During translational motion, the gripping features hold the item in place over a desired distance such that the item does not slide off or move from the top side of the conveyor belt until reaching the end of the conveyor belt loop and being conveyed to a desired location for further use/operation. The gripping features may be manufactured from the same or different material as the conveyor belt. Alternatively, instead of a series of rows of ridges, the gripping features may be provided by a grid of textured pegs. A variety of other geometric shapes can also be used provided that the gripping features enhance friction between the top side and the item to be conveyed. Other traction examples include, but are not limited to, perforations, bosses or dimples, etching, sanding/grinding, or other gripping features that are formed or molded.

What is claimed is:

1. A food heating device comprising:
at least one conveyor belt for carrying food products;
at least one platen for heating the food products;
at least one driving mechanism for rotating the at least one conveyor belt in a direction of conveyance travel;
the at least one conveyor belt comprising a loop provided by a unitary, continuous sheet of metal, the loop having a top side and a bottom side, the top side being substantially parallel to and facing the at least one platen;
wherein the at least one conveyor belt moves relative to the at least one platen and transports a food product to allow the food product to be exposed to the at least one platen.

2. The food heating device of claim 1, wherein the bottom side of the continuous sheet metal is reinforced with a rubber coating and adapted to interact with the at least one driving mechanism.

3. The food heating device of claim 1, wherein the top side of the at least one conveyor belt comprises a plurality of dividing structures extending vertically from the top side.

4. The food heating device of claim 3, wherein the plurality of dividing structures is oriented in a direction parallel to the direction of conveyance travel of the at least one conveyor belt.

5. The food heating device of claim 3, wherein the plurality of dividing structures is oriented in a direction perpendicular to the direction of conveyance travel of the at least one conveyor belt.

6. A food heating device comprising:
at least one conveyor belt for carrying food products;
at least one platen for heating the food products;
at least one driving mechanism for rotating the at least one conveyor belt in a direction of conveyance travel;
the at least one conveyor belt comprising a loop provided by a mesh formed from a plurality of interlocked and inseparable rings, the loop having a top side and a bottom side, the top side being substantially parallel to and facing the at least one platen;
wherein the at least one conveyor belt moves relative to the at least one platen and transports a food product to allow the food product to be exposed to the at least one platen.

7. The food heating device of claim 6, wherein the bottom side of the continuous sheet metal is reinforced with a rubber coating and adapted to interact with the at least one driving mechanism.

8. The food heating device of claim 6, wherein the top side of the at least one conveyor belt comprises a plurality of dividing structures extending vertically from the top side.

9. The food heating device of claim 8, wherein the plurality of dividing structures include at least one dividing structure having angled sides.

10. The food heating device of claim 9, wherein the angled sides are one of convex and concave, or combinations thereof.

11. A food heating device comprising:
a conveyor belt for carrying food products, the conveyor belt forming a loop, the conveyor belt comprising a loop provided by a unitary, continuous sheet of metal, the loop having a top side and a bottom side, the conveyor belt comprising a receiving surface and an inner surface;
a heat source for heating food products, the heat source disposed within the conveyor belt loop and configured to heat the conveyor belt;
wherein the conveyor belt moves relative to the at least one heat source and transports a food product to allow the food product to be exposed to the least one heat source.

12. The food heating device of claim 11, wherein at least one of the inner surface and receiving surface is reinforced with a rubber coating.

13. The food heating device of claim 11, wherein the at least one heat source is an inductive heat coil.

14. The food heating device of claim 11, wherein the conveyor belt comprises a mesh of interlocking and inseparable rings.

15. The food heating device of claim 11, wherein the conveyor belt comprises a woven fibrous material.

16. The food heating device of claim 11, wherein the receiving surface of the conveyor belt comprises a plurality of dividing structures extending vertically from the receiving surface.

17. The food heating device of claim 16, wherein the plurality of dividing structures is oriented in a direction parallel to a direction of conveyance travel of the conveyor belt.

18. The food heating device of claim 16, wherein the plurality of dividing structures is oriented in a direction perpendicular to a direction of conveyance travel of the conveyor belt.

19. The food heating device of claim 11, wherein the conveyor belt comprises a plastic material.

20. The food heating device of claim 11, wherein the conveyor belt comprises a loop provided by a unitary, continuous sheet of metal.
